(19) United States
(12) Patent Application Publication
(10) Pub. No.: US 2019/0000095 A1
(43) Pub. Date: Jan. 3, 2019

(54) BONE REMOVAL DEVICE FOR CHICKEN BONJIRI

(71) Applicant: MATOYA TECHNICAL SYSTEM ENGINEERING INDUSTRY CO., LTD., Soo-city, Kagoshima (JP)

(72) Inventor: Hukuichi MASUDOME, Soo-city, Kagoshima (JP)

(21) Appl. No.: 15/506,913

(22) PCT Filed: Sep. 12, 2016
(86) PCT No.: PCT/JP2016/076738

§ 371 Date: Feb. 27, 2017

(30) Foreign Application Priority Data
Mar. 22, 2016 (JP) 2016-057073

(51) Int. Cl. A22C 21/00; A22B 5/00; A22B 5/20

(52) U.S. Cl. CPC A22C 21/0069; A22C 21/0053; A22C 21/0046; A22B 5/202; A22B 5/0035

(57) ABSTRACT

A bone removal device for a chicken bonjiri includes a rotating conveyor mechanism that moves a plurality of receivers which are arrayed in a circumferential direction about a center of a disc taken as a support shaft, intermittently at a constant speed in a horizontal direction and rotates; a holder of a stamping punch mechanism that stamps and removes a coccyx in each of the bonjiris, which are mounted on the receivers, from the bonjiri in a state where this rotating conveyor mechanism is stopped; and an arm of a processed meat delivery mechanism that carries the bonjiri, from which such a bone is removed, out to the device by reversing each of the receivers.

### BACKGROUND OF THE INVENTION

The present invention relates to a device for removing a coccyx from a bonjiri, which is a Japanese word meaning a chicken rump present in a tail portion of a chicken, the bonjiri being a protruding meat portion as a triangle corresponding to such a tail of the chicken, being a rare edible portion that covers a periphery of the coccyx and is obtained by only a very small amount, being juicy, pleasant to the taste and most richest in the chicken in terms of oil, and being an important portion eaten as a grilled chicken on a skewer, or the like.

As a device for removing bones from meat, for example, there are proposed: one in which a sclerite removal device for removing sclerites such as cartilages and nerves, which are mixed into the meat, is additionally provided in a chopper for processing the meat into minced meat (refer to Japanese Patent Laid-Open Publication No. 2007-44024); and a device in which a plurality of slits which prevent predetermined foreign objects such as sclerites from passing therethrough are formed in the chopper, the device removing bones by scraping minced meat, which has passed through the slits, by a scraper (refer to Japanese Patent No. 3191024). Moreover, there is proposed a meat bone removal device that has a configuration in which, toward a downstream from a charge station, a scapula removal station, which has a predetermined interval from the charge station, and a humerus removal station, which has the same predetermined interval, are disposed linearly at an equal interval, a bone portion discharge station, which discharges a humerus, is provided downstream of the humerus removal station, a work is subjected to tact conveyance in a suspended state via a fixed and movable conveyance passages, and is subjected to bone removal processing in a process of this conveyance, and such a humerus thus removed is discharged from a final station (discharge station) (refer to Japanese Patent No. 4327099). Besides, there is disposed an automatic bone removal device for meat with a bone, which grasps an exposed neck portion of the meat with the bone by a suspension portion, performing cutting guideline forming processing for the meat along a longitudinal direction of the bone in a state where the meat is suspended, thereafter, peels off the meat on a periphery of the bone, and thereby removes the bone (refer to Japanese Patent No. 4908148).

### SUMMARY OF THE INVENTION

However, such bone removal work for the bonjiri has not been mechanized yet, and has still been left to a manual operation of cutting in the meat into a V shape by a knife and taking out the coccyx. Therefore, the bonjiri is a commercial product with low profitability, and it has been desired that the bone removal work be mechanized.

In consideration of the problem in the above-described conventional technology, it is an object of the present invention to provide a bone removal device for a chicken bonjiri, which is capable of reducing labor in the removal work for the coccyx present in the bonjiri, and is capable of performing the removal work for the bone in the bonjiri safely and efficiently.

For this purpose, a bone removal device for a chicken bonjiri according to the present invention has a first feature in that the bone removal device is composed of: a bone removal mechanism including a receiver (dice cup) which is formed so that a bonjiri of a chicken can be mountable thereon, and in addition, has a punch hole formed in a bottom thereof, and a punch that stamps a coccyx in the bonjiri; and a processed meat delivery mechanism that carries out meat, which is already subjected to bone removal processing, while interlocking with a bone removal operation. Moreover, the bone removal device has a second feature in that a recessed portion on which the bonjiri is mountable is formed in the receiver, and the bone removal device further includes: an upper cover (coupling) in which a recessed portion fittable to a contour of the bonjiri is formed in a state where the bonjiri is mounted on the receiver; a cylindrical punch for removing a bone, the cylindrical punch being mounted on the upper cover; and an ejector that pushes out the coccyx from an inside of the punch for removing a bone. Furthermore, the bone removal device has a third feature in that the bone removal device further includes: a rotating conveyor mechanism that determines a plurality of the receivers intermittently at a constant speed in a horizontal direction, the receivers being arrayed in a circumferential direction about a center of a disc taken as a support shaft; and a punch mechanism that stamps and removes, from the bonjiri mounted on each of the receivers, the coccyx in the bonjiri in a state where the conveyor mechanism is stopped. Still further, the bone removal device has a fourth feature in that the receivers are arranged one by one linearly at a fixed pitch, and are linearly conveyed by a belt, a chain, or a cylinder. Moreover, the bone removal device has a fifth feature in that the processed meat delivery mechanism is a mechanism of reversing the receivers. In addition, the bone removal device has a sixth feature in that the processed meat delivery mechanism is a chuck claw mechanism that grasps and conveys the processed meat or a lifter mechanism that thrusts up the processed meat from below and separates the processed meat apart from each of the receivers.

### BRIEF DESCRIPTION OF THE DRAWINGS

FIG. 1 is a partial cross-sectional side view showing an overall configuration of a removal device for bonjiri according to the present invention.

FIG. 2 is a plan view showing a disc and a punch mechanism.

FIG. 3 is a partial cross-sectional side view showing a state where the bonjiri is set on the disc (lower die).

FIG. 4 is a partial cross-sectional side view showing a state where a coccyx is punched out from the bonjiri.

FIG. 5 is a main portion-enlarged cross-sectional view showing another embodiment (chuck claw) of a takeout mechanism for the bonjiri already subjected to bone removal processing.

FIG. 6 is a main portion-enlarged cross-sectional view of still another embodiment (lifter) of the takeout mechanism for the bonjiri already subjected to the bone removal processing.

### DETAILED DESCRIPTION OF THE INVENTION

Hereinafter, a description will be made of an embodiment of a device of the present invention in accordance with the drawings.

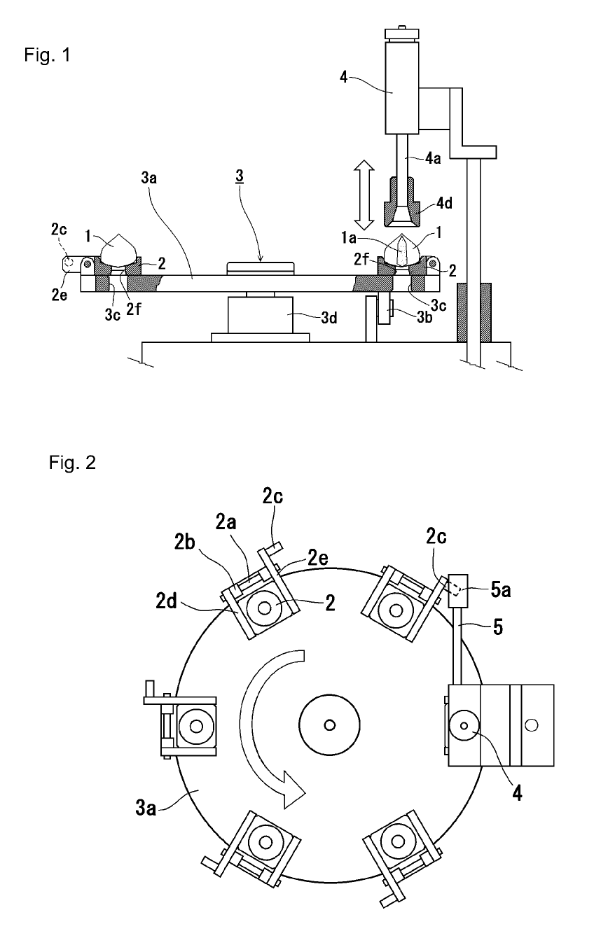

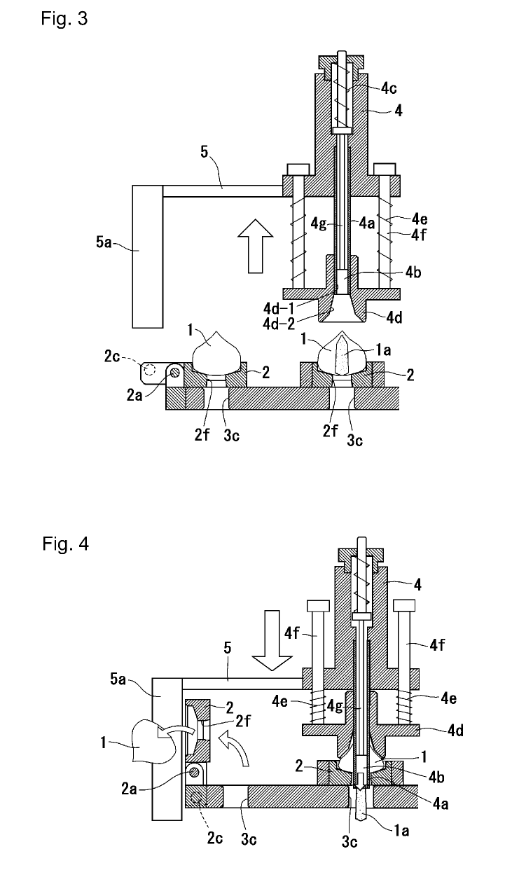

As shown in FIG. 1 and FIG. 2, a bone removal device for a chicken bonjiri according to the present invention is composed of: a rotating conveyor mechanism 3 that determines a plurality of receivers (dice cups) 2, which are arrayed in a circumferential direction about a center of a disc 3a taken as a support shaft, intermittently at a constant speed in a horizontal direction, the receivers 2 including recessed portions on which bonjiris 1 are mountable; a stamping punch mechanism holder 4 that stamps and removes a coccyx 1a in each of the bonjiris 1, which are mounted on the receivers 2, from the bonjiri 1 in a state where this rotating conveyor mechanism 3 is stopped; and an arm 5 of a delivery mechanism that carries the bonjiri 1, from which such a bone is removed, out to the device by reversing the receiver 2.

On a center of a bottom of each of the receivers 2, a punch hole 2f for inserting a cylindrical punch 4a therethrough from the above, the punch hole 2f corresponding to a die for stamping the coccyx 1a from an inside of the bonjiri 1, is formed. The recessed portion on a periphery of the punch hole 2f is formed into a smooth conical dish shape so that the coccyx 1a of the bonjiri 1 can be located on a center of the receiver 2, and so as to be capable of coping with a difference in size of the coccyx 1a due to an individual difference of the chicken. Moreover, a depression pin 2c of the receiver 2 is depressed by a depression rod 5a attached to the arm of the delivery mechanism 5 at substantially a right angle so as to face downward, the depression rod 5a being coupled to the holder of the stamping punch mechanism 4 and interlocking therewith in a vertical direction, whereby the receiver 2 is reversed by 90 degrees, and is thus made capable of delivering only a portion of processed meat of the bonjiri 1 from which the bone is removed.

That is to say, the receiver 2 is configured to serve as a lower die that has the conical recessed portion and such a bone drawing hole 2f on the center of the bottom thereof, to cause both sides thereof to be sandwiched by a receiver support guide 2d and a depression pin-attached receiver support guide 2e, which make a pair, and to be capable of rotating to 90 degrees (to a substantially vertical direction) about a support shaft 2a, arranged in support shaft guides, that couples these to each other. Moreover, the depression pin 2c is attached to the depression pin-attached receiver support guide 2e as one piece in the pair. Note that such receivers 2 may be arranged one by one linearly at a fixed pitch, and may be linearly conveyed by a belt, a chain or a cylinder.

At a position above the receiver 2, which is coaxial therewith, a conical punch hole 4d-1 is provided, and above the punch hole 4d-1, a conical hole 4d-2 for punching is provided continuously with the punch hole 4d-1. With regard to a pressing cover 4d, an outer circumference thereof is held on the stamping punch mechanism holder 4 by a plurality of support rods 4f so as to be movable vertically, and the pressing cover 4d is always urged downward by springs 4e of the pressing cover, which are wound around and attached to the support rods 4f.

Through a center of such an upper cover 4d, a cylindrical and hollow punch 4a is inserted, and a coccyx ejector (pushing-out bar) 4b is provided in such a hollow. The holder 4 of the stamping punch mechanism moves vertically in a regular manner by an unillustrated method, and the arm 5 and depression rod 5a of the processed meat delivery mechanism, which are coupled to the stamping punch mechanism holder 4, also move vertically following this motion.

The conveyor mechanism 3 circulates and conveys the plurality of receivers 2, which are arrayed in the circumference direction on the disc 3a, through a process from the charge of the bonjiris 1 through the removal of the bones therefrom to the delivery of the processed meat of the bonjiris 1 after the removal of the bones while rotationally moving the receivers 2 intermittently at a constant speed while interlocking with the stamping punch mechanism holder 4.

In the holder 4 of the stamping punch mechanism, the pressing cover (coupling) 4d having a conical shape, that is, a trumpet shape, which is expanded downward in diameter, is coupled to the plurality of support rods 4f so as to be movable vertically, and so as to be capable of bounding by the pressing cover springs 4e, the cylindrical punch 4a is pressed against an outer circumference of the coccyx 1a from above the bonjiri 1, and the coccyx 1a is removed so as to be stamped. Only the coccyx 1a can be surely removed while preventing the pressing cover 4d from applying excessive force to the bonjiri 1 by the springs 4e of the pressing cover. Moreover, the coccyx ejector 4b is depressed with appropriate force applied by a spring 4c to the coccyx ejection 4b through a coccyx thrusting bar 4g of the coccyx ejector, and accordingly, the coccyx 1a stamped by the punch 4a is surely discharged without remaining in a cylindrical inside of the cylindrical punch 4a.

The arm 5 of the processed meat delivery mechanism is configured to perform an elevating operation following the holder 4 of the stamping punch mechanism, and as mentioned above, by the depression rod 5a, the arm 5 depresses the depression pin 2c of the receiver 2, and thereby reverses the receiver 2 by 90 degrees about the support shaft 2a thereof based on the principle of leverage, and delivers the bonjiri 1 from which the bone is removed.

That is to say, the device of this embodiment is configured to have a structure, in which the plurality of receivers (dice cups) 2 are placed on the circumference of the disc 3a, and are made rotatable about the center of the disc 3a intermittently at a constant speed in the circumferential direction, and the cylindrical punch 4a is moved vertically to stamp the meat portion on the periphery of the coccyx 1a of the bonjiri 1 while pressing and fixing the bonjiri 1 by the pressing cover (coupling) 4d.

Next, a description will be made of bone removal operations by the device of this embodiment.

An operator manually mounts the bonjiris 1 on the receivers 2 on the stopped disc 3a while directing sharp sides of the bonjiris 1 upward. Then, when the disc 3a moves rotationally, one of the bonjiris 1 set on the receivers 2 is conveyed to a point below the cylindrical punch 4a, and the disc 3a is stopped when the cylindrical punch 4a and the receiver 2 are located coaxially with each other, then the cylindrical punch 4a moves down.

Then, on an outer circumference of a lower portion of the cylindrical punch 4a, the conical pressing cover 4d, which is attached thereto so as to be vertically slidable, covers a tip end side of the bonjiri 1, and the coccyx 1a in the bonjiri 1 is stamped by the punch 4a while being fixed so as not to cause a lateral shake, and when the punch 4a reaches a lowermost point, the coccyx 1a is stamped apart from the bonjiri 1, and the coccyx 1a passes through the through hole 2f of the receiver 2 and a through hole 3c of the disc 3a, then falls down, and is removed.

When the cylindrical punch 4a goes up after the bone is removed, then the disc 3a rotates again, and the bone removal device repeats the above-mentioned operations, and carries the processed meat out while performing such bone removal for the next bonjiri 1.

With regard to the carrying out of the processed bonjiri 1, the depression pin 2c of the receiver 2 for the bonjiri 1 from which the bone is removed is depressed by the depression bar 5a of the processed meat delivery mechanism 5 coupled to the stamping punch mechanism 4, whereby the receiver 2 is reversed by 90 degrees about the support shaft 2a thereof based on the principle of leverage, and the bonjiri 1 is delivered.

Note that the disc 3a also receives pressing force in a case where the coccyx 1a is stamped by the punch, and accordingly, it is necessary to resist this pressing force; however, in this embodiment, a roller 3b in contact with a lower surface of the disc 3a is provided, and this roller 3b receives the pressing force while rotating.

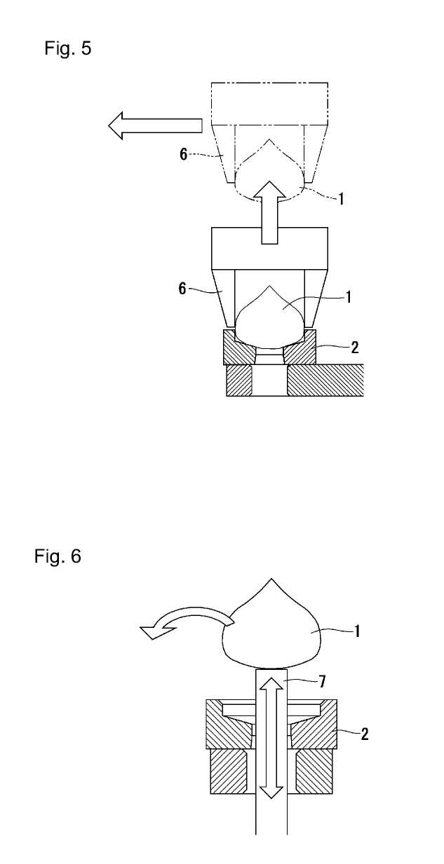

Note that, besides such a mechanism as described above of reversing the receiver 2, the processed meat delivery mechanism may be such a mechanism as shown in FIG. 5, which uses a chuck claw 6 that grasps and conveys the processed bonjiri 1, or may be such a mechanism as shown in FIG. 6, which uses a lifter 7 that thrusts up the processed meat from below and separates the processed meat from the receiver 2.

In accordance with the device of the present invention, the bone removal work for the bonjiri can be performed extremely efficiently at a speed a few times a speed of the manual work.

1. A bone removal device for a chicken bonjiri, the bone removal device comprising:
a bone removal mechanism including a receiver (dice cup) which is formed so that a bonjiri of a chicken can be mountable thereon, and in addition, has a punch hole formed in a bottom thereof, and a punch that stamps a coccyx in the bonjiri; and
a processed meat delivery mechanism that carries out meat, which is already subjected to bone removal processing, while interlocking with a bone removal operation.

2. The bone removal device for a chicken bonjiri according to claim 1,
wherein a recessed portion on which the bonjiri is mountable is formed in the receiver, and
the bone removal device further comprises:
an upper cover in which a recessed portion fittable to a contour of the bonjiri is formed in a state where the bonjiri is mounted on the receiver;
a cylindrical punch for removing a bone, the cylindrical punch being mounted on the upper cover; and
an ejector that pushes out the coccyx from an inside of the punch for removing a bone.

3. The bone removal device for a chicken bonjiri according to claim 1, further comprising:
a rotating conveyor mechanism that moves a plurality of the receivers intermittently at a constant speed in a horizontal direction, the receivers being arrayed in a circumferential direction about a center of a disc taken as a support shaft; and
a punch mechanism that stamps and removes, from the bonjiri mounted on each of the receivers, the coccyx in the bonjiri in a state where the conveyor mechanism is stopped.

4. The bone removal device for a chicken bonjiri according to claim 1, wherein the receivers are arranged one by one linearly at a fixed pitch, and are linearly conveyed by a belt, a chain or a cylinder.

5. The bone removal device for a chicken bonjiri according to claim 1, wherein the processed meat delivery mechanism is a mechanism of reversing the receivers.

6. The bone removal device for a chicken bonjiri according to claim 1, wherein the processed meat delivery mechanism is a chuck claw mechanism that grasps and conveys the processed meat or a lifter mechanism that thrusts up the processed meat from below and separates the processed meat from each of the receivers.
